(19) United States
(12) Patent Application Publication
(10) Pub. No.: US 2017/0170669 A1
(43) Pub. Date: Jun. 15, 2017

(54) METHOD FOR MANAGING CAPACITY OF LITHIUM ION BATTERY

(71) Applicants: JIANGSU HUADONG INSTITUTE OF LI-ION BATTERY CO., LTD., Suzhou (CN); TSINGHUA UNIVERSITY, Beijing (CN)

(72) Inventors: Li Wang, Beijing (CN); Xiang-Ming He, Beijing (CN); Ao-Jun Bai, Beijing (CN); Jian-Jun Li, Beijing (CN); Yu-Ming Shang, Beijing (CN); Jian Gao, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/442,493

(22) Filed: Feb. 24, 2017

Related U.S. Application Data
(63) Continuation of application No. PCT/CN2015/081710, filed on Jun. 17, 2015.

(30) Foreign Application Priority Data
Aug. 25, 2014 (CN) 201410420983.4

(51) Int. Cl. H02J 7/00; H01M 10/44; H01M 10/48; H01M 10/0525

(52) U.S. Cl. CPC H02J 7/0016; H01M 10/0525; H01M 10/44; H01M 10/488; H02J 7/0068

(57) ABSTRACT

A method for managing capacity of lithium ion battery is disclosed. A warning capacity D or C is preset for a discharge process or a charge process. Two anode active materials are mixed and used to form a lithium ion battery. The lithium ion battery is discharged or charged, during which the voltage of the battery is monitored. When the voltage of the lithium ion battery is in a range, a warning is generated for a remaining discharge capacity of the first lithium ion battery reaching the warning capacity D, or a charging capacity of the lithium ion battery reaching the warning capacity C.

### CROSS-REFERENCE TO RELATED APPLICATIONS

This application claims all benefits accruing under 35 U.S.C. §119 from China Patent Application No. 201410420983.4, filed on Aug. 25, 2014 in the State Intellectual Property Office of China, the contents of which are hereby incorporated by reference. This application is a continuation of international patent application PCT/CN2015/081710 filed Jun. 17, 2015, the content of which is hereby incorporated by reference.

### FIELD

The present disclosure relates to the field of lithium ion battery management, and particularly relates to methods for managing capacities of lithium ion batteries.

### BACKGROUND

Battery remaining capacity, also known as the battery state of charge (SOC) is an important parameter reflecting battery state and can be used as a basis for controlling and managing electric vehicles. Maintaining the SOC within a reasonable range can prevent damage to the battery caused by overcharge or overdischarge, achieve a rational application of the battery to improve battery life, fully exert battery power performance, and reduce maintenance costs of the battery system.

Current SOC estimation strategies include an open circuit voltage (OCV) method, an ampere-hour counting method, a fuzzy neural network method, and a Kalman filtering method. The fuzzy neural network method and the Kalman filtering method are complicated methods, which need to analyze and model date of battery. Moreover, restricted by hardware of the battery management system and maturity of the algorithms themselves, the vast majority research results of the two methods still remain in the computer simulation stage and are far from practical application. The OCV method and ampere-hour counting method, which are simple and effective, are still the most commonly used SOC estimation methods at present.

The OCV method establishes a remaining capacity-open circuit voltage (SOC-OCV) curve based on a monotonic relationship between the OCV and the SOC, and determines the SOC value according to the detected OCV value. However, the OCV method requires a strict measurement of the SOC-OCV relationship, which is only for batteries having significant SOC changes with the OCV. The OCV method is not suitable for a lithium iron phosphate battery, which is a representative of the current lithium ion battery, as the battery has a relatively flat SOC-OCV curve resulting from a relatively flat charge/discharge voltage plateau thereof. In addition, even for the lithium ion battery with a steep enough SOC-OCV curve, the determination of the SOC will also be affected if the measurement of the absolute voltage is inaccurate. The ampere-hour counting method calculates an integral value of charge/discharge current in a time period during work of the battery system, and then estimates the dynamic SOC value of the battery. As the ampere-hour counting method requires a high accuracy of the current sampling, the estimation result may have errors, and the errors accumulate with time. So in practice, the result of the ampere-hour counting method is usually corrected by using the SOC-OCV curve of the OCV method combined thereto. Nevertheless, for the lithium ion battery, the flat SOC-OCV curve has little significance to the correction.

### BRIEF DESCRIPTION OF THE DRAWINGS

FIG. 1 is a graph showing a rate discharge curve of a first lithium ion battery in a first embodiment.

FIG. 2 is a graph showing a discharge curve a of a lithium iron phosphate half cell, a charge curve b of a half cell using a third anode active material formed by mixing graphite and phosphorus-carbon composite material, a calculated discharge curve c of a full cell obtained by subtracting voltage of curve b from voltage of curve a, and a real tested discharge curve d of a full cell.

FIG. 3 is a graph showing a rate charge curve of a second lithium ion battery in a second embodiment.

FIG. 4 is a graph showing a charge curve a of the lithium iron phosphate half cell, a discharge curve b of the half cell using the third anode active material formed by mixing graphite and phosphorus-carbon composite material, a calculated charge curve c of the full cell obtained by subtracting voltage of curve b from voltage of curve a, and a real tested charge curve d of the full cell.

FIG. 5 is a graph showing rate charge curves of the half cell in Example 1 using the third anode active materials having different x values.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

A first embodiment of a method for managing discharge capacity of lithium ion battery is disclosed, and the method comprises:

S11, presetting a warning capacity (or warning capacity percentage) D of a first lithium ion battery for a discharge process, wherein 0<D<100%;

S12, mixing a first anode active material and a second anode active material to obtain a third anode active material, and forming a first lithium ion battery by using the third anode active material and a cathode active material;

S13, discharging the first lithium ion battery, and monitoring voltage of the first lithium ion battery during the rate discharging; and when the voltage is in a range from V0-V21 to V0-V12, generating a warning for the remaining discharge capacity of the first lithium ion battery reaching the warning capacity D. In the present disclosure, “V0”, “V11”, “V12”, “V21”, “V22”, “V5”, “V31”, “V32”, “V41”, and “V42” represent voltage values, as further explained below. The “-” between two voltage values, such as in “V0-V21”, “V0-V22”, “V0-V11”, “V0-V12”, “V5-V32”, “V5-V41”, “V5-V31”, “V5-V42,” is a minus sign to represent the operation of subtraction between the two voltage values.

In S11, the warning capacity D can be decided by actual need. For example, when the first lithium ion battery needs to be overcharged, D can be set as 50% to 95%.

In S12, after the mixing, the first and second anode active materials do not change crystal structures of each other. The potential of the first anode active material relative to lithium metal is lower than the potential of the second anode active material relative to lithium metal. The specific capacity of the first anode active material is M mAh/g. The specific capacity of the second anode active material is N mAh/g. A mass percentage x of the second anode active material in the third anode active material satisfies x=(k1−D)M/[(k1−D)M+DN], wherein k1 is a correction coefficient, which is a constant, and 0.9<k1<1.1.

In S13, a discharge voltage plateau of the cathode active material is V0. A charge voltage plateau of the first anode active material is from V11 to V12. A charge voltage plateau of the second anode active material is from V21 to V22. V21 is greater than V12.

The cathode active material can be doped or undoped spinel lithium manganese oxide, layered lithium manganese oxide, lithium nickel oxide, lithium cobalt oxide, lithium iron phosphate, lithium nickel manganese oxide, lithium nickel cobalt oxide, or any combination thereof. Specifically, the formula of the spinel lithium manganese oxide can be LiₘMn₂₋ₙLₙO₄. The formula of the lithium nickel oxide can be LiₘNi₁₋ₙLₙO₂. The formula of the lithium cobalt oxide can be LiₘCo₁₋ₙLₙO₂. The formula of the layered lithium manganese oxide can be LiₘMn₁₋ₙLₙO₂. The formula of the lithium iron phosphate can be LiₘFe₁₋ₙLₙPO₄. The formula of the lithium nickel manganese oxide can be LiₘNi_{0.5+z-a}Mn_{1.5-z-b}LₐR_{b}O₄. The formula of the lithium nickel cobalt manganese oxide can be LiₘNi_{c}Co_{d}MnₑL_{f}O₂. In the above formulas, 0.1≦m≦1.1, 0≦n<1, 0≦z<1.5, 0≦a−z<0.5, 0≦b+z<1.5, 0<c<1, 0<d<1, 0<e<1, 0≦f≦0.2, c+d+e+f=1. L and R represent at least one of the chemical elements of alkali metal elements, alkaline-earth metal elements, Group-13 elements, Group-14 elements, transition metal elements, and rare-earth elements. In one embodiment, L and R represent at least one of the chemical elements of Mn, Ni, Cr, Co, V, Ti, Al, Fe, Ga, Nd, and Mg.

The first anode active material and the second anode active material can be one of lithium titanate, graphite, titanium dioxide, and phosphorus-carbon composite material. The lithium titanate can be doped or undoped lithium titanate with spinel type structure. The formula of the undoped lithium titanate can be Li₄Ti₅O₁₂, the formula of the doped lithium titanate can be Li_{(4-g)}A_{g}Ti₅O₁₂ or Li₄AₕTi₍₅₋ₕ₎O₁₂, wherein 0<g≦0.33 and 0<h≦0.5. In the formula, A represents at least one of the chemical elements of alkali metal elements, alkaline-earth metal elements, Group-13 elements, Group-14 elements, transition metal elements, and rare-earth elements. In one embodiment, A represents at least one of the chemical elements of Mn, Ni, Cr, Co, V, Al, Fe, Ga, Nd, and Mg. The phosphorus-carbon composite material is a phosphorus composite formed by adsorpting sublimated phosphorus in pores of porous carbon material. The phosphorus-carbon composite material is capable of having an electrochemical reversible lithium storage. The phosphorus in the composite is capable of storing lithium, and the porous carbon is capable of enhancing electrochemical property of the phosphorus. The phosphorus-carbon composite material has a relatively high specific capacity and electrical conductivity.

The charge/discharge voltage plateau of the cathode active material or the anode active material in the present disclosure refers to a voltage plateau exhibited when the half cell is charged/discharged, and the half cell is constructed by the cathode active material and the lithium metal, or by the anode active material and the lithium metal. When a cathode active material or an anode active material is charged/discharged in its half cell, the voltage thereof goes through three periods, e.g., the rising/falling, the relatively stable, and the other rising/falling. The relatively stable period is the longest in the three periods. This relatively stable period is the charge/discharge voltage plateau of the cathode active material or the anode active material. That is, when the cathode active material or the anode active material is charged/discharged in its half cell, the charge/discharge curve exhibits two slope-discontinuity points. The charge/discharge curve between the two slope-discontinuity points can be defined as the charge/discharge voltage plateau of the cathode active material or the anode active material. The two slope-discontinuity points are a starting point and an ending point of the charge/discharge voltage plateau.

In S13, the discharge stage V0 of the cathode active material can be a middle value between the voltage values corresponding to the two slope-discontinuity points on the discharge curve of the half cell constructed by the cathode active material and the lithium metal. Since the cathode active material in general has a long and smooth charge/discharge voltage plateau, the above-mentioned middle value can be used to represent the discharge voltage plateau of the cathode active material. V11 and V12 are voltage values corresponding to the starting point and the ending point of the charge voltage plateau of the first anode active material, respectively. V21 and V22 are the voltage values corresponding to the starting point and the ending point of the charge voltage plateau of the second anode active material, respectively.

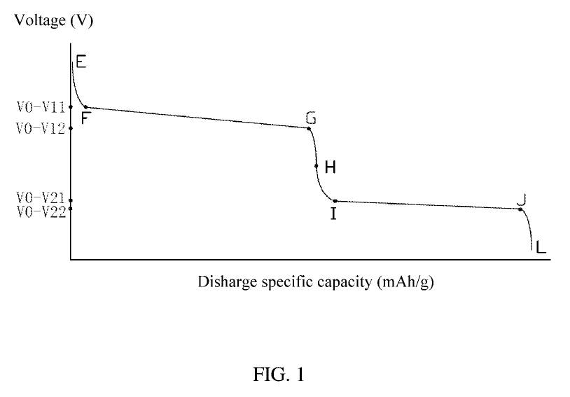

Referring to FIG. 1, in the discharge process of the first lithium ion battery, the first anode active material that has the lower potential relative to lithium metal is discharged first (see the section from E to H in FIG. 1). After the discharging of the first anode active material substantially ends, the discharging of the second anode active material, which has the higher potential relative to lithium metal, starts (see the section from H to Lin FIG. 1). When the first anode active material stops discharging and the second anode active material starts to discharge (corresponding to point H in FIG. 1), the remaining discharge capacity of the first lithium ion battery is the preset D.

The charging in the half cell of the anode active material corresponds to its discharging in the full cell, and the discharging in the half cell of the anode active material corresponds to its charging in the full cell. Therefore, when discharging a full cell that is constructed by a cathode active material and an anode active material, the discharge curve of the full cell has a remarkable matching relationship with the discharge curve of the cathode active material and the charge curve of the anode active material. When charging a full cell that is constructed by a cathode active material and an anode active material, the charge curve of the full cell has a remarkable matching relationship with the charge curve of the cathode active material and the discharge curve of the anode active material. The voltage of the full cell should be the potential difference between the two electrodes relative to lithium metal. The overlapped period of the voltage plateaus of the two electrodes is a stable period of the full cell.

In the discharge curve of the first lithium ion battery, the discharge voltage plateau corresponding to the first anode active material is the section from F to G, and the F point and the G point are respectively the starting point and the ending point of the discharge voltage plateau corresponding to the first anode active material. The voltage Vf at the point F is (V0-V11), and the voltage Vg at the point G is (V0-V12). The discharge voltage plateau corresponding to the second anode active material is the section from I to J, and the point I and the point J are respectively the starting point and the ending point of the discharge voltage plateau corresponding to the second anode active material. The voltage Vi at the point I is (V0-V21), and the voltage Vj at the point J is (V0-V22). The discharge curve of the first lithium ion battery jumps from the section F-G to the section I-J around the time when the remaining discharge capacity of the lithium ion battery reaches D. At this time, the discharge curve of the first lithium ion battery appears an acute voltage difference change starting from Vg at point G and ending to Vi at point I. As the voltage difference between the point G to point I changes intensely, the discharge curve in this section has a steep slope. Therefore, any voltage value within the voltage range between Vi and Vg can be used as an indication that the remaining capacity of the first lithium ion battery reaches D.

The voltage Vh at the point H is the actual voltage corresponding to the preset D of the first lithium ion battery, therefore an error may occur by using the other voltage value as indicated in the section from G to I. But the slope of the curve from G to I is very steep due to the terminal voltage effect of the electrode material at the beginning and ending of the discharge. Therefore, the error is relatively small and does not exceed 5% in general. To further reduce this error, a range of (Vh−pVh) to (Vh+pVh) can be used as a warning range for the remaining discharge capacity of the first lithium ion battery reaching the preset value D, 0<p<10%. In one embodiment, the warning can be generated when the voltage value of the first lithium ion battery is exactly Vh. The middle value between the voltage Vg at the point G and the voltage Vi at the point I can be regarded as the voltage value Vh at the point H, i.e., Vh=(Vg+Vi)/2. That is, Vh=(V0-V21+V0-V12)/2.

In addition, the first anode active material and the second anode active material can have different percentages in the third anode active material. The voltages at the starting points and the ending points of the voltage plateaus corresponding to the first and second anode active material does not change with the ratio between the first anode active material and the second anode active material. However, the acute voltage change caused by jumping from the voltage plateau of the first anode active material to the voltage plateau of the second anode active material appears at different location changing with that ratio. The remaining capacity of the first lithium ion battery corresponding to the acute voltage change is also different and changing with that ratio. x represents the mass percentage of the second anode active material in the third anode active material. The mass percentage of the first anode active material in the third anode active material is (1−x). When the first anode active material finishes the discharging and the second anode active material starts to discharge, the theoretical remaining discharge capacity (Dt) of the first lithium ion battery can be calculated by Dt=(1−x)M/[(1−x)M+xN]. The actual remaining discharge capacity D at the mixing ratio can be calculated by correcting the theoretical remaining discharge capacity Dt using the correction coefficient k1 to calculate the at the mixing ratio, and D=k1Dt=k1(1−x)M/[(1−x)M+xN]. By presetting the value D, the mass percentage of the second anode active material in the third anode active material can be calculated by x=(k1−D)M/[(k1−D)M+DN]. The correction coefficient k1 is constant, 0.9<k1<1.1, and can be set specifically depending on the material properties of the cathode and anode active materials used in the first lithium ion battery.

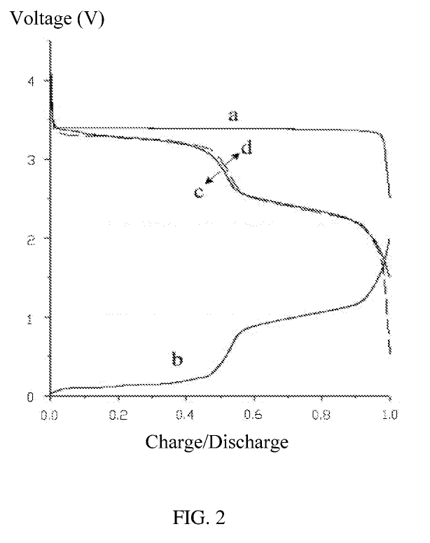

Referring to FIG. 2, in one embodiment, the cathode active material is lithium iron phosphate, the first anode active material is graphite, and the second anode active material is the phosphorus-carbon composite material. FIG. 2 shows the discharge curve a of the lithium iron phosphate half cell, the charge curve b of the half cell using the third anode active material formed by mixing the graphite and the phosphorus-carbon composite material, the calculated discharge curve c of the first lithium ion battery obtained by subtracting voltage of curve b from voltage of curve a, and the real tested discharge curve d of the first lithium ion battery. From FIG. 2 it can be seen that curve c and curve d are almost coincident. Therefore, in this embodiment, k1 can be set as k1=1.

When the remaining capacity of the first lithium ion battery reaches D, a warning can be given to the battery management system to perform a next step, for example, to stop discharging the first lithium ion battery thereby preventing the first lithium ion battery from over discharge.

Before S12, the method can further comprise: measuring the correction coefficient k1, in order to more precisely manage the remaining discharge capacity of the first lithium ion battery during actual use, comprising:

S21, forming a plurality of first lithium ion batteries respectively by having varied values x1, x2, x3, . . . x(n−1), xn for x, wherein 0<x1<1, 0<x2<1, 0<x3<1, . . . , 0<x(n−1)<1,0<xn<1, and other conditions are the same for the plurality of first lithium ion batteries;

S22, discharging the plurality of first lithium ion batteries respectively, reading values listed in the following table from the discharge curves of the plurality of first lithium ion batteries, and making a list by using the values; and

| x | x1 | x2 | x3 | . . . | x(n − 1) | xn |
|---|---|---|---|---|---|---|
| Vg | Vg1 | Vg2 | Vg3 | . . . | Vg(n − 1) | Vgn |
| Vi | Vi1 | Vi2 | Vi3 | . . . | Vi(n − 1) | Vin |
| Vh | Vh1 | Vh2 | Vh3 | . . . | Vh(n − 1) | Vhn |
| D | D1 | D2 | D3 | . . . | D(n − 1) | Dn |
| Dt | Dt1 | Dt2 | Dt3 | . . . | Dt(n − 1) | Dtn |
| D/Dt | D1/Dt1 | D2/Dt2 | D3/Dt3 | . . . | D(n − 1)/Dt(n − 1) | Dn/Dtn |

S23, calculating k1, wherein

k1=[D1/Dt1+D2/Dt2+D3/Dt3. . . +D(n−1)/Dt(n−1)+Dn/Dtn]/n.

Vg is the voltage at the ending point of the discharge voltage plateau of the first anode active material on the discharge curve of the first lithium ion battery. Vi is the voltage at the starting point of the discharge voltage plateau of the second anode active material on the discharge curve of the first lithium ion battery. Vh=(Vg+Vi)/2. D is the remaining discharge capacity at Vh on the discharge curve of the first lithium ion battery. Dt is the theoretical remaining discharge capacity corresponding to x, Dt=(1−x)M/[(1−x)M+xN].

In S12, x=(k1−D)M/[(k1−D)M+DN] can be calculated based on the preset D and k1 obtained in S23, and then the first lithium ion battery can be formed by using the calculated x.

Further, Vg, Vi and Vh can be corrected by using the data of the above table to obtain the corrected Vg′, Vi′ and Vh′, wherein:

Vg′=[Vg1+Vg2+Vg3 . . . +Vg(n−1)+Vgn]/n,

Vi′=[Vi1+Vi2+Vi3 . . . +Vi(n−1)+Vin]/n,

Vh′=[Vh1+Vh2+Vh3 . . . +Vh(n−1)+Vhn]/n.

In S13, the voltage of the first lithium ion battery is monitored during the discharging. And when the voltage falls within the range from Vg′ to Vi′, the warning is generated for the remaining discharge capacity of the first lithium ion battery reaches D. In some embodiments, the warning can be generated when the voltage of the first lithium ion battery falls within the range from (Vh′−pVh′) to (Vh′+pVh′), 0<p<10%. In one embodiment, the warning can be generated when the voltage of the first lithium ion battery is equal to Vh′.

A second embodiment of the method for managing charge capacity of lithium ion battery is disclosed, and the method comprises:

S31, presetting a warning capacity (or warning capacity percentage) C of a second lithium ion battery for a charge process, and 0<C<100%;

S32, mixing a first anode active material and a fourth anode active material to obtain a fifth anode active material, and forming a second lithium ion battery by using the fifth anode active material and a cathode active material;

S33, rate charging the second lithium ion battery, and monitoring voltage of the second lithium ion battery during the rate charging; and when the voltage is in a range from V5-V32 to V5-V41, generating a warning for the charging capacity of the second lithium ion battery reaching the warning capacity C.

In S32, after the mixing, the first and fourth anode active materials do not change crystal structures of each other. The potential of the first anode active material relative to lithium metal is higher than the potential of the fourth anode active material relative to lithium metal. The specific capacity of the first anode active material is M mAh/g. The specific capacity of the fourth anode active material is Z mAh/g. A mass percentage y of the fourth anode active material in the fifth anode active material satisfies y=(k2−C)M/[(k2−C)M+CZ], wherein k2 is a correction coefficient, which is a constant, and 0.9<k2<1.1.

In S33, a charge voltage plateau of the cathode active material is V5. A discharge voltage plateau of the first anode active material is from V31 to V32. A discharge voltage plateau of the fourth anode active material is from V41 to V42. V32 is greater than V41.

The fourth anode active material can be one of lithium titanate, graphite, titanium dioxide, and phosphorus-carbon composite material. The lithium titanate can be doped or undoped lithium titanate with spinel type structure. The formula of the undoped lithium titanate can be Li₄Ti₅O₁₂, the formula of the doped lithium titanate can be Li_{(4-g)}A_{g}Ti₅O₁₂ or Li₄AₕTi₍₅₋ₕ₎O₁₂, wherein 0<g≦0.33 and 0<h≦0.5. In the formula, A represents at least one of the chemical elements of alkali metal elements, alkaline-earth metal elements, Group-13 elements, Group-14 elements, transition metal elements, and rare-earth elements. In one embodiment, A represents at least one of the chemical elements of Mn, Ni, Cr, Co, V, Al, Fe, Ga, Nd, and Mg. The phosphorus-carbon composite material is a phosphorus composite formed by adsorpting sublimated phosphorus in pores of porous carbon material. The phosphorus-carbon composite material is capable of having an electrochemical reversible lithium storage. The phosphorus in the composite is capable of storing lithium, and the porous carbon is capable of enhancing electrochemical property of the phosphorus.

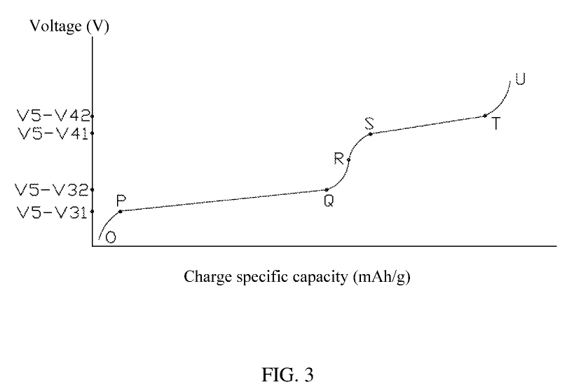

The second embodiment of the method is substantially the same as the first embodiment of the method, except that the potential of the first anode active material relative to lithium metal is higher than the potential of the second anode active material relative to lithium metal. Referring to FIG. 3, during the charging of the second lithium ion battery, the first anode active material that has the higher potential relative to lithium metal is charged first (see the section from O to R in FIG. 3). After the charging of the first anode active material substantially ends, the charging of the fourth anode active material, which has the lower potential relative to lithium metal, starts (see the section from R to Uin FIG. 3). When the first anode active material completes charging and the fourth anode active material starts to charge (corresponding to point R in FIG. 3), the charge capacity of the second lithium ion battery is the preset C.

In the charge curve of the second lithium ion battery, the charge voltage plateau corresponding to the first anode active material is the section from P to Q, and the point P and the point Q are respectively the starting point and the ending point of the charge voltage plateau corresponding to the first anode active material. The voltage Vp at the point P is (V5-V31), and the voltage Vq at the point Q is (V5-V32). The charge voltage plateau of the fourth anode active material is the section from S to T, and the point S and the point T are respectively the starting point and the ending point of the charge voltage plateau of the fourth anode active material. The voltage Vs at the point S is (V5-V41), and the voltage Vf at the point F is (V5-V42). The charge curve of the second lithium ion battery jumps from the section P-R to the section S-T around the time when the charge capacity of the lithium ion battery reaches C. At this time, the charge curve of the first lithium ion battery appears an acute voltage difference change starting from Vq at point Q and ending to Vs at point S. As the voltage difference between the point Q to point S changes intensely, the charge curve in this section has a great slope. Therefore, any voltage value within the voltage range between point Q and point S can be used as an indication that the remaining capacity of the second lithium ion battery reaches C.

The voltage Vr at the point R is the actual voltage corresponding to the preset value C of the second lithium ion battery, therefore an error may occur by using the other voltage value as the indication in the section from Q to S. But the slope of the curve from Q to S is very steep due to the terminal voltage effect of the electrode material at the beginning and ending of the charge. Therefore, the error is relatively small and does not exceed 5% in general. To further reduce this error, a range of (Vr−pVr) to (Vr+pVr) can be used as a warning range for the charge capacity of the second lithium ion battery reaches the preset value C, 0<p<10%. In one embodiment, the warning can be generated when the voltage value of the second lithium ion battery is exactly Vr. The middle value between the voltage Vq at the point Q and the voltage Vs at the point Scan be regarded as the voltage value Vr at the point R, i.e., Vr=(Vq+Vs)/2. That is, Vr=(V5-V32+V5-V41)/2.

y represents the mass percentage of the fourth anode active material in the fifth anode active material. The mass percentage of the first anode active material in the fifth anode active material is (1−y). When the first anode active material finishes the charging and the fourth anode active material starts to charge, the theoretical charge capacity (Ct) of the second lithium ion battery can be calculated by Ct=(1−y)M/[(1−y)M+yZ]. The actual charge capacity C at the mixing ratio can be calculated by correcting the theoretical charge capacity Ct using the correction coefficient k2 to calculate the at the mixing ratio, and C=k2Ct=k2(1−y)M/[(1−y)M+xZ]. By presetting the value C, the mass percentage of the fourth anode active material in the fifth anode active material can be calculated by y=(k2−C)M/[(k2−C)M+CZ]. The correction coefficient k2 is constant, 0.9<k2<1.1, and can be set specifically depending on the material properties of the cathode and anode active materials used in the second lithium ion battery.

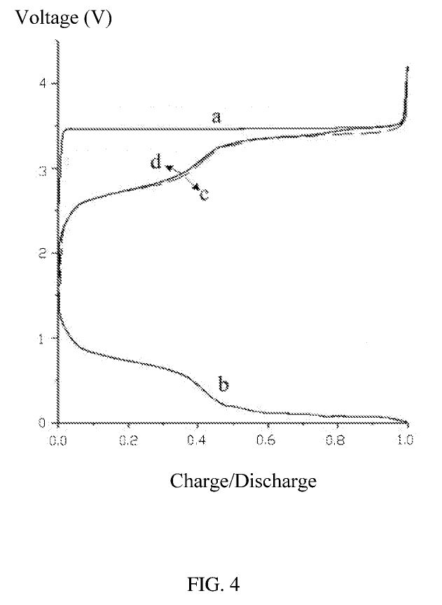

Referring to FIG. 4, in one embodiment, the cathode active material is lithium iron phosphate, the first anode active material is the phosphorus-carbon composite material, and the fourth anode active material is graphite. FIG. 4 shows the charge curve a of the lithium iron phosphate half cell, the discharge curve b of the half cell using the fourth anode active material formed by mixing the graphite and the phosphorus-carbon composite material, the calculated charge curve c of the second lithium ion battery obtained by subtracting voltage of curve b from voltage of curve a, and the real tested charge curve d of the second lithium ion battery. From FIG. 4 it can be seen that curve c and curve d are almost coincident. Therefore, in this embodiment, k2=1.

When the charge capacity of the second lithium ion battery reaches C, a warning can be given to the battery management system to perform a next step, for example, to stop charging the second lithium ion battery thereby preventing the second lithium ion battery from overcharge.

Before S32, the method can further comprise: measuring the correction coefficient k2, in order to more precisely manage the charge capacity of the second lithium ion battery during actual use, comprising:

S41, forming a plurality of second lithium ion batteries respectively by having varied values y1, y2, y3, . . . y(n−1), yn for y, wherein 0<y1<1, 0<y2<1, 0<y3<1, . . . , 0<y(n−1)<1, 0<yn<1, and other conditions are the same for the plurality of second lithium ion batteries;

S42, rate charging the plurality of second lithium ion batteries, reading values listed in the following table from the charge curves of the plurality of second lithium ion batteries, and making a list by using the values; and

| y | y1 | y2 | y3 | . . . | y(n − 1) | yn |
|---|---|---|---|---|---|---|
| Vq | Vq1 | Vq2 | Vq3 | . . . | Vq(n − 1) | Vqn |
| Vs | Vs1 | Vs2 | Vs3 | . . . | Vs(n − 1) | Vsn |
| Vr | Vr1 | Vr2 | Vr3 | . . . | Vr(n − 1) | Vrn |
| C | C1 | C2 | C3 | . . . | C(n − 1) | Cn |
| Ct | Ct1 | Ct2 | Ct3 | . . . | Ct(n − 1) | Ctn |
| C/Ct | C1/Ct1 | C2/Ct2 | C3/Ct3 | . . . | C(n − 1)/Ct(n − 1) | Cn/Ctn |

S43, calculating k2, wherein

k2=[C1/Ct1+C2/Ct2+C3/Ct3 . . . +C(n−1)/Ct(n−1)+Cn/Ctn]/n.

Vq is the voltage at the ending point of the charge voltage plateau of the first anode active material on the charge curve of the second lithium ion battery. Vs is the voltage at the starting point of the charge voltage plateau of the fourth anode active material on the charge curve of the second lithium ion battery. Vr=(Vq+Vs)/2. C is the charge capacity at Vr on the charge curve of the second lithium ion battery. Ct is the theoretical charge capacity corresponding to y, Ct=(1−y)M/[(1−y)M+yZ].

In S32, y=(k2−C)M/[(k2−C)M+CZ] can be calculated based on the preset C and k2 obtained in S43, and then the second lithium ion battery can be formed by using the calculated y.

Further, Vq, Vs and Vr can be corrected by using the data of the above table to obtain the corrected Vq′, Vs' and Vr′, wherein:

Vq′=[Vq1+Vq2+Vq3 . . . +Vq(n−1)+Vqn]/n;

Vs′=[Vs1+Vs2+Vs3 . . . +Vs(n−1)+Vsn]/n;

Vr′=[Vr1+Vr2+Vr3 . . . +Vr(n−1)+Vrn]/n.

In S33, the voltage of the second lithium ion battery is monitored during the charging. And when the voltage falls within the range from Vq′ to Vs′, the warning is generated for the charge capacity of the second lithium ion battery reaches C. In some embodiments, the warning can be generated when the voltage of the second lithium ion battery falls within the range of (Vr′−pVr′) to (Vr′+pVr′), 0<p<10%. In one embodiment, the warning can be generated when the voltage of the second lithium ion battery is equal to Vr′.

### Example 1

Graphite and phosphorus-carbon composite material are mixed in different ratios to fabricate the lithium ion half cells. The method for preparing the lithium ion half cell is as follows:

(1) Graphite, phosphorus-carbon (P—C) composite material (containing 40% of phosphorus), and acetylene black are weighed, and PVDF (dissolved with N-methyl pyrrolidone to have a mass percentage of 10%) is added to satisfy:

(graphite+P—C composite material):acetylene black:PVDF=7:2:1(mass ratio).

Then, the viscosity is adjusted by further adding N-methyl pyrrolidone, wherein the total mass of graphite, P—C composite material, acetylene black, and PVDF is 0.5 g, and about 1.5 mL of N-methyl pyrrolidone is added. The materials are put into a mortar and mixed.

(2) A copper foil is provided, and the surface thereof is wiped clean with alcohol, and glued to a glass plate. After the surface of the copper foil is dried, the mixture in the mortar is poured onto one end of the copper foil, and then blade coated on the surface of the copper foil.

(3) The coated copper foil is dried at about 60° C. in an oven for about 24 hours, and then taken out and punched to form the electrode plate. The electrode plate is dried in a vacuum oven at about 60° C. for about 24 hours.

(4) The dried electrode plate and a lithium metal plate are used as the two electrodes, and LBC305-01 are used as the electrolyte, to assemble a button-type cell as the lithium ion half cell.

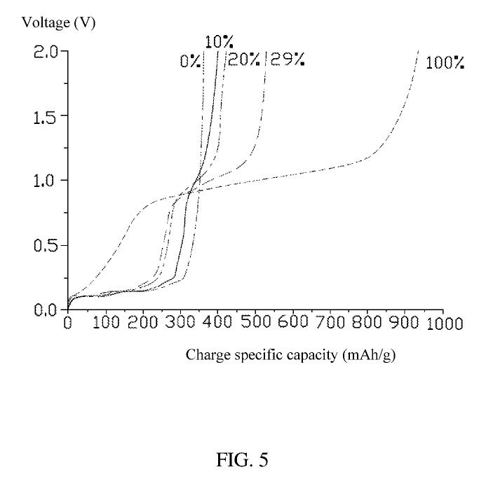

The lithium ion half cells are charged at a charge rate of 0.1 C by using 350 mAh/g as a standard specific capacity. The charging curves of the lithium ion half cell shaving different mixing ratios are shown in FIG. 5. The values are read from the charging curves of the first lithium ion battery and listed in the following table.

| x | 0 | 10% | 20% | 29% | 100% |
|---|---|---|---|---|---|
| Vg | 0.25 V | 0.25 V | 0.25 V | 0.25 V | — |
| Vi | — | 0.75 V | 0.75 V | 0.75 V | 0.75 V |
| Vh | — | 0.5 V | 0.5 V | 0.5 V | — |
| D | — | 302/400 = 75.5% | 265/421 = 62.9% | 253/530 = 47.7% | — |
| Dt | — | 315/419 = 75.1% | 280/488 = 57.4% | 249/550 = 45.3% | — |
| D/Dt | — | 1.005 | 1.096 | 1.053 | — |

Then, k1 is calculated as k1=(1.005+1.096+1.053)/4=1.051, and Vh′=0.5V.

The charge curve of the lithium ion half cell corresponds to the discharge curve of the lithium ion full cell having the mixed graphite and phosphorus-carbon composite material as the third anode active material. The full cell is preset to stop discharging when the remaining discharge capacity is 90% to prevent an over discharge of the battery. The theoretical capacity of graphite is 350 mAh/g. The theoretical capacity of the phosphorus-carbon composite material (containing 40% of phosphorus) is 1038 mAh/g. The mass percentage of graphite in the third anode active material is calculated to be 95.5%. The mass percentage of the phosphorus-carbon composite material in the third anode active material is calculated to be 4.5%. The full cell is formed according to the calculated mass percentages. During the discharging, the voltage of the full cell is monitored, and when the voltage falls within the range from (3.45V-0.5V×110%) to (3.45V-0.5V×90%), which is from 2.9V to 3.00V, the discharging of the full cell is stopped.

In the present method, another anode active material is added to the first anode active material, and the two anode active materials have different voltage plateaus so that the lithium ion battery has two voltage plateaus. A great voltage difference change occurs during the charging and discharging between the two voltage plateaus of the lithium ion battery. The position where the voltage difference change occurs corresponds in a one to one manner to the remaining discharge capacity or the charge capacity of the lithium ion battery, so that the voltage difference change can be detected and used to determine whether the lithium ion battery reaches its corresponding remaining discharge capacity or charge capacity. In addition, the ampere-hour counting method can be corrected by using the correspondence between the position where the voltage difference change occurs and the remaining discharge capacity or the charge capacity of the lithium ion battery.

The present method for managing capacity of lithium ion battery is not only simple, convenient and easy to operate, but also solves the problem of the inaccurate SOC measurement due to the flatness of the voltage plateau and the inaccurate absolute voltage measurement. Thereby, the present method can effectively monitor and manage the battery capacity.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for managing capacity of lithium ion battery, the method comprising:
presetting a warning capacity D of a first lithium ion battery for a discharge process, wherein 0<D<100%;
mixing a first anode active material and a second anode active material to obtain a third anode active material;
forming a first lithium ion battery by using the third anode active material and a cathode active material;
rate discharging the first lithium ion battery, and monitoring voltage of the first lithium ion battery during the rate discharging; and
generating a warning for a remaining discharge capacity of the first lithium ion battery reaching the warning capacity D when the voltage of the first lithium ion battery is in a range from V0-V21 to V0-V12, wherein V0 is a discharge voltage plateau of the cathode active material, a charge voltage plateau of the first anode active material is from V11 to V12, a charge voltage plateau of the second anode active material is from V21 to V22, and V21 is greater than V12.

2. The method of claim 1, wherein a potential of the first anode active material relative to lithium metal is lower than a potential of the second anode active material relative to lithium metal, a mass percentage x of the second anode active material in the third anode active material satisfies x=(k1−D)M/[(k1−D)M+DN], wherein M is a specific capacity of the first anode active material, N is a specific capacity of the second anode active material, k1 is a constant, and 0.9<k1<1.1.

3. The method of claim 1, wherein the warning is generated when the voltage of the first lithium ion battery is in a range from Vh−pVh to Vh+pVh, 0<p<10%, and Vh=(V0-V21+V0-V12)/2.

4. The method of claim 1, wherein the warning is generated when the voltage of the first lithium ion battery is equal to Vh, and Vh=(V0-V21+V0-V12)/2.

5. The method of claim 1, wherein at least one of the first anode active material and the second anode active material is selected from the group consisting of lithium titanate, graphite, titanium dioxide, and phosphorus-carbon composite material.

6. The method of claim 2, further comprising measuring the k1, comprising:
forming a plurality of first lithium ion batteries respectively having varied values xᵢ for the mass percentage x;
rate discharging the plurality of first lithium ion batteries, reading Vgᵢ, Viᵢ, Vhᵢ, and Dᵢ from a discharge curve of each of the plurality of first lithium ion batteries, wherein Vgᵢ represents a voltage at an ending point of the discharge voltage plateau of the first anode active material, Viᵢ represents a voltage at a starting point of the discharge voltage plateau of the second anode active material, Vhᵢ=(Vgᵢ+Viᵢ)/2,Dᵢ represents the remaining discharge capacity of the first lithium ion battery at Vhᵢ; and
calculating k1 wherein
$$k 1 = ( {\sum }_{i = 1}^{n} \frac{{D}_{i}}{D {t}_{i}} ) / n ,$$
n represents an amount of the plurality of the first lithium ion batteries, and Dtᵢ=(1−xᵢ)/[(1−xᵢ)+xᵢN].

7. The method of claim 6, further comprising calculating Vg′ and Vi′ by
Vg′=(Σᵢ₌₁ⁿVgᵢ)/n; and
Vi′=(Σᵢ₌₁ⁿViᵢ)/n
wherein the warning is generated when the voltage of the first lithium ion battery is in a range from Vi′ to Vg′.

8. The method of claim 6, further comprising calculating Vh′ by Vh′=(Σᵢ₌₁ⁿ Vhᵢ)/n, wherein the warning is generated when the voltage of the first lithium ion battery is in a range from Vh′−pVh′ to Vh′+pVh′, 0<p<10%.

9. The method of claim 6, further comprising calculating Vh′ by Vh′=(Σᵢ₌₁ⁿVhᵢ)/n, wherein the warning is generated when the voltage of the first lithium ion battery is equal to the Vh′.

10. A method for managing capacity of lithium ion battery, the method comprising:
presetting a warning capacity C of a second lithium ion battery for a charge process, and 0<C<100%;
mixing a first anode active material and a fourth anode active material to obtain a fifth anode active material;
forming the second lithium ion battery by using the fifth anode active material and a cathode active material;
rate charging the second lithium ion battery, and monitoring voltage of the second lithium ion battery during the rate charging; and
generating a warning for a charging capacity of the second lithium ion battery reaching the warning capacity C when the voltage is in a range from V5-V32 to V5-V41, wherein V5 is a charge voltage plateau of the cathode active material, a discharge voltage plateau of the first anode active material is from V31 to V32, a discharge voltage plateau of the fourth anode active material is from V41 to V42, and V32 is greater than V41.

11. The method of claim 10, wherein a potential of the first anode active material relative to lithium metal is higher than a potential of the fourth anode active material relative to lithium metal, a mass percentage y of the fourth anode active material in the fifth anode active material satisfies y=(k2−C)M/[(k2−C)M+CZ], wherein M is a specific capacity of the first anode active material, Z is a specific capacity of the fourth anode active material, k2 is a constant, and 0.9<k2<1.1.

12. The method of claim 10, wherein the warning is generated when the voltage of the second lithium ion battery is in a range from Vr−pVr to Vr+pVr, 0<p<10%, and Vr=(V5-V32+V5-V41)/2.

13. The method of claim 10, wherein the warning is generated when the voltage of the first lithium ion battery is equal to Vr, and Vr=(V5-V32+V5-V41)/2.

14. The method of claim 10, wherein at least one of the first anode active material and the fourth anode active material is selected from the group consisting of lithium titanate, graphite, titanium dioxide, and phosphorus-carbon composite material.

15. The method of claim 11, further comprising measuring the k2, comprising:
forming a plurality of second lithium ion batteries respectively having varied values yᵢ for the y;
rate charging the plurality of second lithium ion batteries, reading Vqᵢ, Vsᵢ, Vrᵢ, and Cᵢ from a discharge curve of each of the plurality of first lithium ion batteries, wherein Vqᵢ represents a voltage at an ending point of the charge voltage plateau of the first anode active material, Vsᵢ represents a voltage at a starting point of the charge voltage plateau of the fourth anode active material, Vrᵢ=(Vqᵢ+Vsᵢ)/2,Cᵢ represents the charge capacity of the second lithium ion battery at Vrᵢ; and
calculating k2 by
$$k 2 = ( {\sum }_{i = 1}^{n} \frac{{C}_{i}}{C {t}_{i}} ) / n ,$$
wherein n represents an amount of the plurality of the second lithium ion batteries, and Ctᵢ=(1−yᵢ)M/[(1−yᵢ)M+yᵢZ].

16. The method of claim 15, further comprising calculating Vq′ and Vs' by
Vq′=(Σᵢ₌₁ⁿVqᵢ)/n; and
Vs′=(Σᵢ₌₁ⁿVsᵢ)/n;
wherein the warning is generated when the voltage of the second lithium ion battery is in a range from Vq′ to Vs′.

17. The method of claim 15, further comprising calculating Vr′ by Vr′=(Σᵢ₌₁ⁿ Vrᵢ)/n, wherein the warning is generated when the voltage of the second lithium ion battery is in a range from Vr′−pVr′ to Vr′+pVr′, 0<p<10%.

18. The method of claim 15, further comprising calculating Vr′ by Vr′=(Σᵢ₌₁ⁿ Vrᵢ)/n, wherein the warning is generated when the voltage of the first lithium ion battery is equal to the Vr′.
